(19) United States
(12) Patent Application Publication
(10) Pub. No.: US 2013/0151547 A1
(43) Pub. Date: Jun. 13, 2013

(54) METHOD AND SYSTEM FOR GENERATING DOCUMENT RECOMMENDATIONS

(71) Applicant: Tobias Queck, Mountain View, CA (US)

(72) Inventor: Tobias Queck, Mountain View, CA (US)

(73) Assignee: SAP AG, Walldorf (DE)

(21) Appl. No.: 13/316,304

(22) Filed: Dec. 9, 2011

(51) Int. Cl. G06F 17/30

(52) U.S. Cl. 707/767; 707/E17.008

(57) ABSTRACT

A method and system for generating document recommendations is provided. An example system comprises a task commencement detector to detect commencement of a subject task in an enterprise management system, a similar tasks detector to determine one or more further tasks that are same or similar to the subject task, a document access information detector to determine one or more documents from a document management system that were accessed in association with any of the tasks from the one or more further tasks, a document selector to select at least one recommendation document, and a recommendation generator to generate a recommendation comprising the identified recommendation documents.

### TECHNICAL FIELD

This application relates to the technical fields of software and/or hardware technology and, in one example embodiment, to system and method for generating a recommendation based on document access and transactional activities.

### BACKGROUND

In an enterprise, a large amount of documents, e.g. user manuals, educational materials etc., are stored in document management systems. In order to find those documents that may be most helpful in completing a certain task, a user may perform keyword-based search in the document management system. Another approach would be for a user to search social media web sites, such as Internet forums, wikis etc. A user could also directly ask colleagues for recommendations. A standard full-text search helps to find relevant content but it does not provide any information about the quality/usefulness of the located document.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of an example architecture within which an example method and system for generating document recommendations may be implemented;

FIG. 2 is a diagrammatic representation of a network environment within which an example method and system for generating document recommendations may be implemented;

FIG. 3 is block diagram of a system for generating document recommendations, in accordance with one example embodiment;

FIG. 4 is a flow chart of a method for generating document recommendations, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

Method and system for generating document recommendations are described.

In one example embodiment, in order to generate document recommendations, a system may be provided to monitor and collect document access activities of users of enterprise document management systems (DMS) and to correlate these document access activities with activities of the users performed with respect to other enterprise management systems, such as, e.g., Enterprise Resource Planning (ERP) systems. For example, the activity stream or document access information associated with a DMS may be correlated with the activity stream of an ERP system, and the results of the correlating may be utilized to determine, which documents from the DMS are being accessed while various ERP activities are being executed. These determined documents may then be used to create a recommendation (termed a reading recommendation) of one or more documents from the DMS at the time the executing of a certain activity with respect to the ERP system is being detected.

ERP is typically refers to business management software that allows an organization to use a system of applications to manage the business. Some ERP software integrates various facets of an operation, including development, manufacturing, sales and marketing, etc. ERP software includes enterprise software modules that a company would purchase, based on what best meets its specific needs and technical capabilities. Each ERP module is focused on one area of business processes, such as product development or marketing. Some of the more common ERP modules include those for product planning, material purchasing, inventory control, distribution, accounting, marketing, finance and HR. A document management system (DMS) may be a computer system used to track and store electronic documents and/or images of paper documents.

As used herein, a “document” refers to electronic media content that is accessible by computer technology. For example, a document can be a file that is not an executable file or a system file and includes data for use by a computer program. An example of a document 100 includes a single or multiple files that are accessible by and/or associated with electronic document processing applications such as word processing applications, document viewers, email applications, presentation applications, spreadsheet applications, diagramming applications, graphic editors, graphic viewers, enterprise applications, and other applications. Therefore, as explained in more detail below, a document may be composed of alphanumeric texts, symbols, images, videos, sounds, and other data. It should be appreciated that a document can have a variety of file formats that, for example, may be identified by data within a document and/or by the filename extension. Examples of file formats that may be associated with document 100 include Adobe Portable Document Format (PDF), Microsoft DOC format, Hypertext Markup Language (HTML) format, Extensible Markup Language (XML) format, Microsoft XLS format, Tag Image File Format (TIFF), Rich TextFormat (RTF), and Report File Format (RPT).

In one example embodiment, the document access information may be collected by a tracking module that may be included into an existing DMS. A tracking module may be configured to track information with respect to users' access of documents provided by the DMS. Information being tracked by a tracking module may include, e.g., the time when a document has been downloaded, the time when a document has been opened, the time when a document has been printed, etc. Other information that can be tracked with respect to a document and utilized for generating reading recommendations may include duration of a user's access of a document, which page of a document has been accessed and for how long, etc. Data collected with respect of user's access of a document may be stored as records comprising one or more fields.

In order to monitor and collect document access information, a closed system may be created that includes a document storage component of a DMS, a client-side reading application, and a server-side DMS component for distribution of documents to the client. As users access documents provided by a DMS, the document access information is collected, e.g., via a DMS web application executing in a web browser hosted at a client computer system or by a mobile or desktop client application configured to collect such access information. In some embodiments, document access information may be collected by a web browser plug-in and provided to the server-side DMS component. The document storage component of a DMS and a server-side DMS component that distributes documents to client systems (e.g., a DMS web application) may be referred to, collectively, as an eLibrary. The document access information may be referred to as reading metadata. The reading metadata may be stored as part of the respective documents or as associated with the respective documents, e.g., using tags, such as a document intended use tag, a category tag, etc. The reading metadata of a document thus comprises information about access to the document by one or more users and about which tasks provided by an enterprise management system were being executed at that time.

The activities of a user in enterprise management systems can be collected in several different ways. State of the art web-based applications usually offer so-called activity feeds that contain all activities of users. More mature software products offer logs, from which the activities can be extracted. In some cases, an enterprise management system may need to be instrumented to permit publishing activities of the activities of users. In the latter case, the instrumentation may be done for selected processes, e.g., for those processes where recommendations could create the highest benefits, such as, e.g., work order management process or sales process. Data associated with monitored activities may include a timestamp, activity identifier, as well as other information, and may be stored as records comprising one or more fields.

The collected information with respect to activities of users in the context of an enterprise management system, as well as the collected information with respect to users accessing documents from the eLibrary provided to a recommendation engine. A recommendation engine may be implemented as a stand-alone computing application, or as part of another application, e.g., as part of an enterprise management system for which user activity data is being collected or as part of an eLibrary. A recommendation engine may include a CEP (complex event processing) module configured to determine, based on a collection of predetermined rules, whether a certain document or a set of documents is to be recommended to a user who is charged with performing a certain task in an enterprise management system, and, if so, create a recommendation and provide it to a client computer system of the user.

Operations performed by a recommendation engine for determining, which documents can be recommended to a user may be triggered by the recommendation engine detecting commencement of a new task in an enterprise management system. A detected new task may be termed a subject task. In one example embodiment, a recommendation engine may be configured to identify all documents that have been accessed by users while working on tasks that are the same or similar to the subject task. Some examples of using a recommendation engine for determining which documents can be recommended to a user are described below.

A computer-implemented management system may use the concept of transactions to encapsulate a task that consists of several steps that have to be executed in a defined order. Some example tasks may be “Create a Sales Order” task (transaction id=VA01), “Modify a Sales Order” task (VA02) and “Display a Sales Order” task (VA03). These three example tasks may be bundle in a program that is called “Sales Order Management” and may be tread by the recommendation engine as similar tasks. If a user wishes to create a sales order, he uses VA01 task as the subject task and the eLibray can be used to recommend documents that have been accessed while other users were performing the same task as the subject task (VA01) or tasks that are similar to the subject task, such as VA02 or VA03, which are part of the same program “Sales Order Management.” Another example of recommending documents from the eLibrary as being potentially useful in completing a subject task provided by an enterprise management system is a work order management scenario. In a “Plant Maintenance” computing application (which may be a part of an ERP system), a work order may be mapped to an object representing a piece of equipment and also to task type. An object representing a piece of equipment may also have a specific type and a unique identification (id). If a user gets a work order for a piece of equipment with an id “123” and the type of the piece of equipment being “X,” and the task type being “Check status.” The recommendation engine may examine documents that have been accessed by other users while performing the “Check status” task with respect to the piece of equipment having the “123” id, and also documents that have been accessed by other users while performing other tasks of type “Check status” for equipment of the same type “X.” The recommendation engine thus may be configured to determine similarity of tasks based on a variety of criteria, such as in examples described above. In some embodiments, tasks provided by an enterprise management system may be identified as similar based on the relationship between data objects on which respective tasks operate. For example, objects representing respective pieces of equipment may be organized into an equipment hierarchy. The recommendation engine may be configured to treat two tasks of the same type as similar if both tasks were executed on respective pieces of equipment that have the same parent in the equipment hierarchy.

After identifying all documents that have been accessed by users while working on tasks that are the same or similar to the subject task, the recommendation engine may examine the information about these identified documents and select a certain number of most relevant documents that have been identified as most relevant to the subject task. The selecting of the most relevant documents may be performed based on various predetermined rules. Some of example rules that may be used to determine respective rankings of the identified documents are shown in Table 1 below.

TABLE 1
Average reading duration above a predetermined threshold → recommend
as mostly used
Number of times above a predetermined threshold a document has been
the last one accessed before finishing a task → recommended as best
to finish the task
Number of times above a predetermined threshold a document has been
the first to be read after getting a task assigned → recommend as
best to start with

Recommendations generated by a recommendation engine may be delivered to a user's client system via a variety of means. For the visualization of the delivered reading recommendation there the following components may be utilized: a web browser (as a web client), a dedicated client (e.g., any kind of a computer application, such as a desktop widget or a Google® gadget), or an extension to an existing client application (e.g., a sidebar in a graphical user interface (GUI) of an enterprise management system or a plugin for an email client). As a delivery method, a push concept may also be used, e.g., where a server generates and pushes reading recommendations to the client application in response to a triggering event (e.g., in response to detecting that a task has been assigned to a user). A pull approach may also be used, e.g., where a client explicitly requests a reading recommendation for a currently active task from the server.

In some embodiments, a system for generating document recommendations may also be configured to determine which documents are not being accessed while a certain task from an enterprise management system is being executed. This information may be used to update an existing published list of potentially relevant documents with respect to tasks in an enterprise management system.

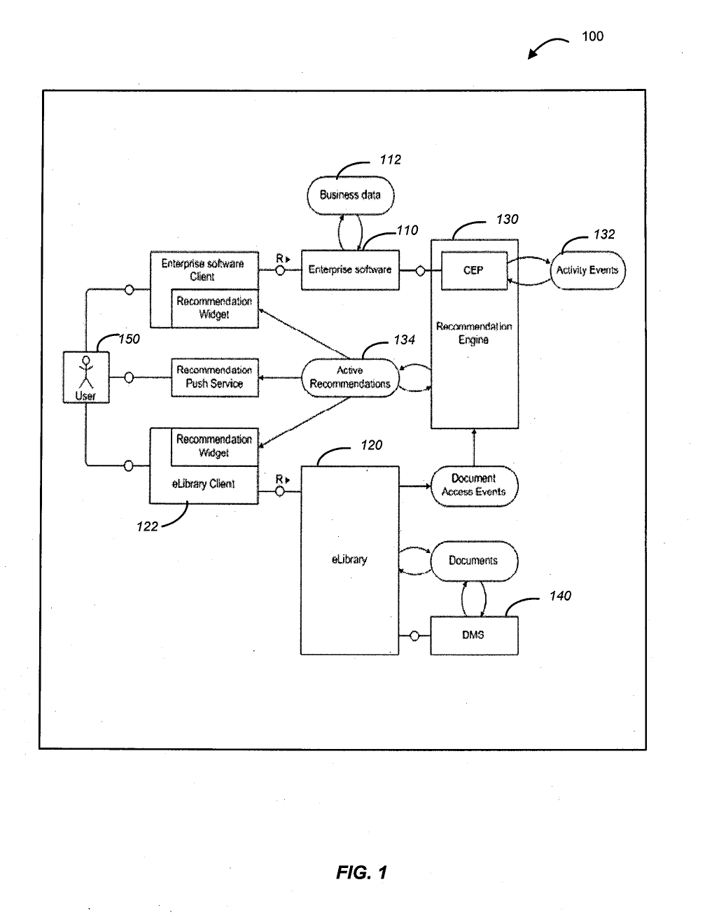

Example architecture 100 for generating document recommendations is illustrated in FIG. 1. Shown in FIG. 1, are event-enabled enterprise software 110, eLibrary server 120 (also referred to as merely eLibrary), and a recommendation engine 130 with a CEP (complex event processing) module. The event-enabled enterprise software 110 may be an enterprise software component that permits triggering custom actions based on an event detected within the system. For example, an Enterprise Resource Planning (ERP) system permits a developer to add custom code to the existing code that is to be executed when a transaction is reaching a certain predetermined function. Such a mechanism may be used to publish evens (or event tracking information) from the event-enabled enterprise software 110 to the CEP module of the recommendation engine 130 and to a database storing business data 112.

The eLibrary server 120, in one example embodiment, is a content hub that may be implemented as a standalone application or as the front end to a document management system (DMS) 140. The eLibrary server 120, in one embodiment, is deployed with a client application—an eLibrary client 122—configured to permit users to access content provided by the eLibrary server 120. The eLibrary server 120 may be configured to cooperate with an eLibrary client 122 in order to collect statistical information (also termed access statistics) with respect to users accessing documents from the eLibrary server 120. The access statistics may be collected using a generic client (e.g., a browser application rendering one or more web pages equipped with statistics-gathering functionality) or, e.g., the eLibrary client 122, and the eLibrary server. In one embodiment, information collected at the client-side is sent to a tracking module that may reside and/or be part of the eLibrary server 120. The access statistics collected at a client may include information such as a timestamp t indicating that a document has been opened at t, page p1 value indicating a page in the document that has been opened at time t2, page p2 value indicating a page in the document that has been opened at time t2, and timestamp t3 indicating the time when the document was closed.

The eLibrary server 120 may receive the collected information and convert it into an appropriate format, as needed, and may also calculate values indicating how long the document has been opened and how often each page has been opened. In addition, the eLibrary server 120 may also collect information such as the type of a client to which a document has been downloaded (e.g., a browser application or a certain type of a mobile client), whether and when a document has been printed, whether and when a document d has been edited by a user, etc.

The recommendation engine 130 may be configured to analyze and process activities (also termed events or activity events) generated published by the enterprise software 110. The recommendation engine 130, in one embodiment, determines which events (or what kind of event tracking information) published by the enterprise software 110 trigger a reading recommendation, based on predetermined rules. For example, one or more predetermined rules may indicate that task assignment events published by the enterprise software 110 are to trigger a process to create reading recommendations for the associated task.

Independent of the source systems (here, independent of the eLibrary server 120 and the enterprise software 110), when the CEP module of the recommendation engine 130 may detect a new task being started at the enterprise software 110, the recommendation engine 130 commences monitoring, analyzing, and storing events associated with the new task (activity events 132). In some embodiments, the activity events 132 associated with the detected tasks are stored in a columnar database running in-memory.

As explained above, the recommendation engine 130 may be configured to examine information about all documents that have been accessed by users while working on a certain task provided by the enterprise software 110 and generate one or more reading recommendations (also termed active recommendations) with respect to those documents that have been identified as most relevant, based on predetermined rules. Active recommendations 134 generated by the recommendation engine 130 may be delivered to a user 150 via a variety of means. For example, active recommendations 134 may be delivered using a recommendation push service 136 (that delivers recommendations via email, instant messaging (IM), text messaging, etc.). Active recommendations 134 may also be delivered utilizing respective recommendation widgets that may be provided with an enterprise software client 160 or with the eLibrary client 122.

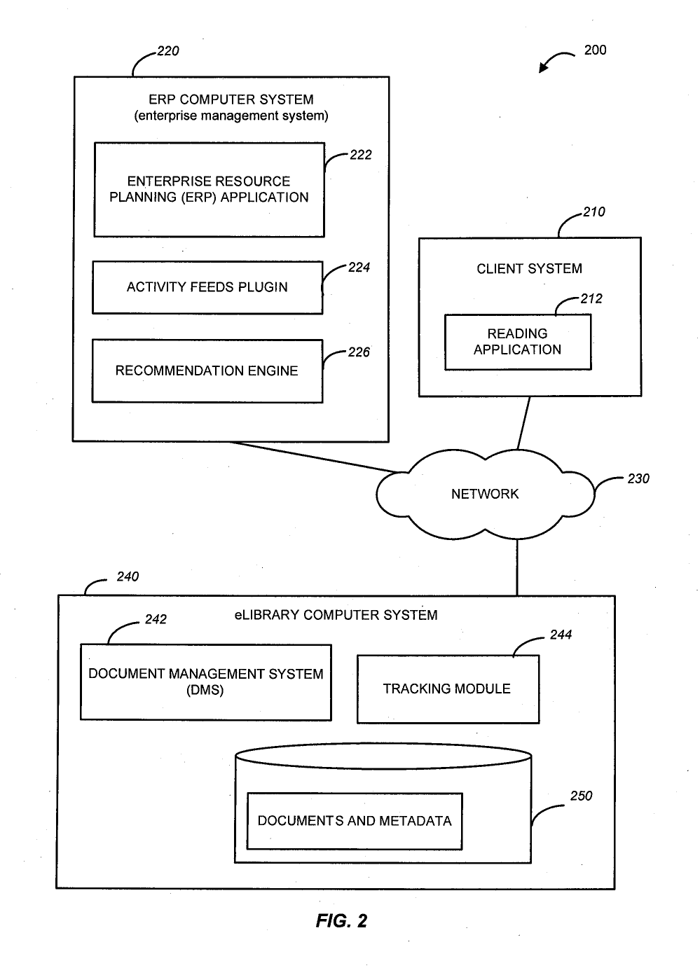

In some embodiments reading recommendations may be visualized using, e.g., an email program or a web browser application executing on a client computer system controlled by the user 150 (where recommendations are delivered to the client computer system by a server-side module that may be provided as part of the enterprise software 110, the eLibrary server 120, or the recommendation engine 130). An example method and system for generating document recommendations may be implemented in the context of a network environment illustrated in FIG. 2.

As shown in FIG. 2, the network environment 200 includes a client computer system 210, an ERP (Enterprise Resource Planning) computer system 220, and an eLibrary computer system 240. While the ERP (Enterprise Resource Planning) computer system 220 and the eLibrary computer system 240 are shown in FIG. 2 as distinct computer systems hosting the ERP system 222 and the DMS system 242 respectively, in some embodiments, the ERP system 222 and the DMS system 242 may be hosted at the same computer system, which may be a distributed computer system. The client computer system 210 is in communication with the ERP computer system 220 and the eLibrary computer system 240 via a communications network 230. The communications network 230 may be a public network (e.g., the Internet, a wireless network, etc.), a private network (e.g., a local area network (LAN), a wide area network (WAN), Intranet, etc.), a local connection such as a connection via a universal serial bus (USB.

The ERP computer system 220 comprises an ERP application 222 configured to manage projects comprising tasks in an enterprise computing environment and an activity feeds plugin 224 configured to collect data associated with tasks that are being created, assigned, and executed in the ERP application 222. The data associated with tasks that are being created, assigned, and executed in an enterprise management system, such as in the ERP application 222, may be referred to as events tracking information. The eLibrary computer system 240 comprises a document management system (DMS) 242 configured to provide access to content that may be stored in a storage repository 250, and a tracking module 244 configured to monitor and track information with respect to users' access of documents provided by the DMS 242. As mentioned above, with reference to FIG. 1, information with respect to users' access of documents provided by a document management system may also be tracked by a client-side recommendation widget. The client computer system 210 may access content provided by the document management system (DMS) 242 utilizing a reading application.

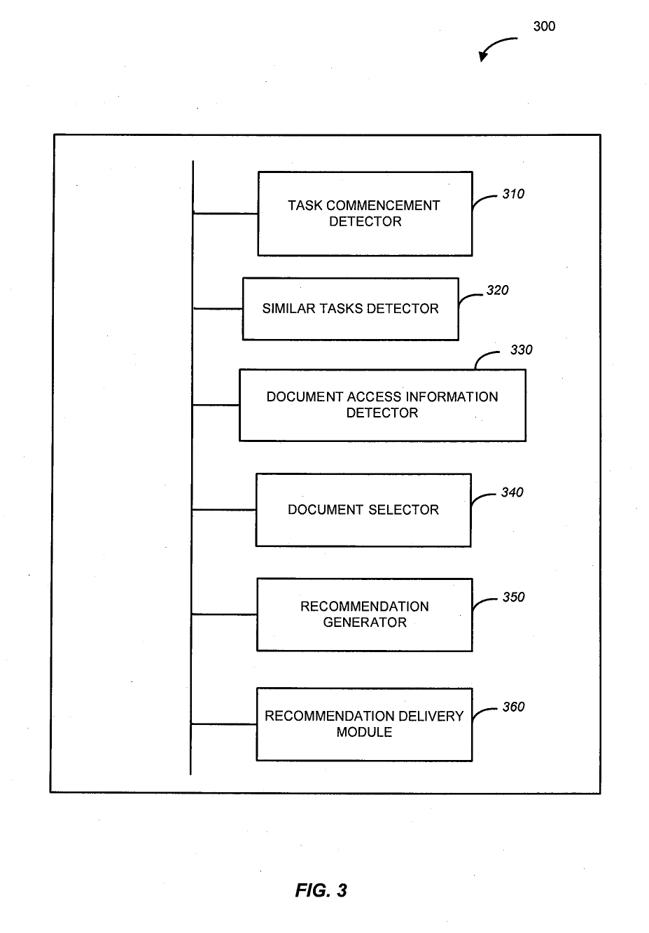

Shown in FIG. 2 is a recommendation engine 226 hosted by the eLibrary computer system 240. In some embodiments, the recommendation engine 226 corresponds to the recommendation engine 130 shown in FIG. 1. As mentioned above, a recommendation engine may be implemented as a stand-alone computing application, or as part of another application, e.g., as part of an enterprise management system for which user activity data is being collected or as part of an eLibrary and may be hosted by any computer system that can obtain or receive document access information and events tracking information. An example system for generating document recommendations may be described with reference to FIG. 3.

FIG. 3 is a block diagram of a system 300 for generating document recommendations, in accordance with one example embodiment. As shown in FIG. 3, the system 300 includes a task commencement detector 310, a similar tasks detector 320, a document access information detector 330, a document selector 340, and a recommendation generator 350. The task commencement detector 310 may be configured to detect commencement of a task (referred as a subject task) in an enterprise management system, e.g., in an ERP application 222 of FIG. 2. The similar tasks detector 320 may be configured to determine one or more (or, in some embodiments, all) further tasks in the enterprise management system that are same or similar to the subject task. The document access information detector 330 may be configured to determine one or more documents from a document management system (e.g., from the DMS 242 of FIG. 2) that were accessed while any of the tasks from the one or more further tasks were being executed. In some embodiments, the document access information detector 330 may be configured to determine, which documents from a document management system have not been accessed while the one or more further tasks were being executed, in order to update an existing published list of potentially relevant documents with respect to tasks in an enterprise management system.

The document selector 340 may be configured to select at least one document that has been identified as sufficiently relevant to be recommended to a user charged with or in the process of performing the subject task. A determination of whether a document is relevant enough to be recommended to a user charged with performing the subject task may be performed based on the results of examining reading metadata associated with the document. As explained above, the reading metadata comprises information about access to a document by one or more users in association the one or more tasks provided by an enterprise management system, such as reading duration (e.g., the time duration during which a document has been opened by a user while performing the subject task) or frequency of access (e.g., the number of times a document has been the last one accessed before finishing a task or the number of times a document has been the first to be read after a task has been assigned). A document that has been identified as relevant enough to be recommended to a user may be referred to as a recommendation document. As explained above, the document selector 340 may identify a document as relevant based on predetermined selection rules, such as, e.g., example rules shown in Table 1 above. The recommendation generator 350 may be configured to generate a recommendation comprising the identified recommendation documents.

Also shown in FIG. 2 is a recommendation delivery module 360. The recommendation delivery module 360 may be configured to deliver the recommendation to a client computer system associated with a user performing the subject task.

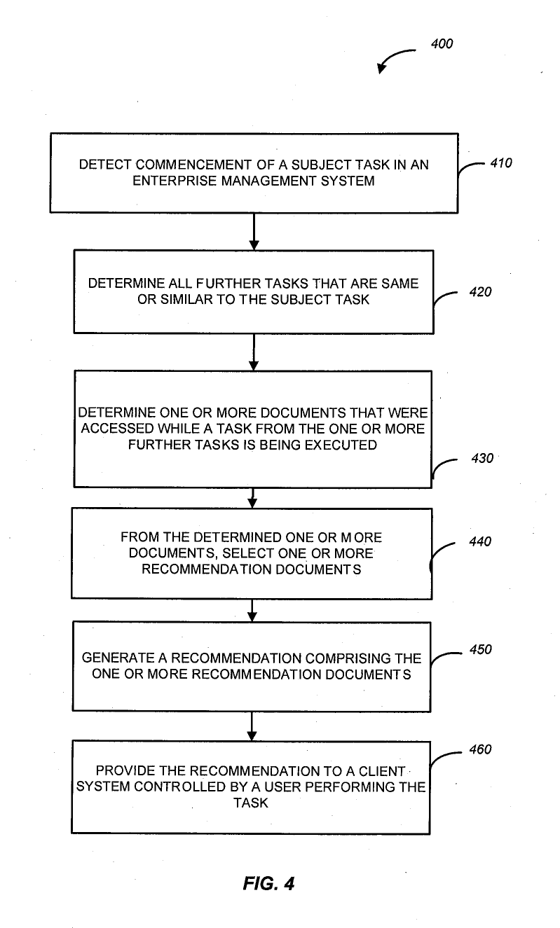

Various modules illustrated in FIG. 3 may be implemented as software, hardware, or a combination of software and hardware, utilizing at least one processor. An example method for generating document recommendations can be described with reference to FIG. 4.

FIG. 4 is a flow chart of a method 400 for generating document recommendations, according to one example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the system 300 shown in FIG. 3.

As shown in FIG. 4, the method 400 commences at operation 410, where the task commencement detector 310 detects commencement of a subject task in an enterprise management system, e.g., in an ERP application 222 of FIG. 2. At operation 420, the similar tasks detector 320 determines one or more further tasks in the enterprise management system that are same or similar to the subject task. As mentioned above, the similar tasks detector 320 may be configured to detect all further tasks in the enterprise management system that are same or similar to the subject task. At operation 430, the document access information detector 330 determines one or more documents from a document management system (e.g., from the DMS 242 of FIG. 2) that were accessed while any of the tasks from the one or more further tasks were being executed. As mentioned above, in some embodiments, the document access information detector 330 may be configured to determine which documents from a document management system have not accessed while a task from the one or more further tasks was being executed. This information may be used beneficially to update an existing published list of potentially relevant documents with respect to tasks in an enterprise management system.

At operation 440, the document selector 340 selects at least one recommendation document that has been identified as sufficiently relevant to be recommended to a user charged with performing the subject task. As mentioned above, the determination of whether a document is relevant enough to be recommended to a user charged with performing the subject task may be performed based on the results of examining reading metadata associated with the document. At operation 450, the recommendation generator 350 generates a recommendation comprising the identified recommendation documents. The recommendation delivery module 360 delivers the recommendation to a client computer system associated with a user performing the subject task at operation 460.

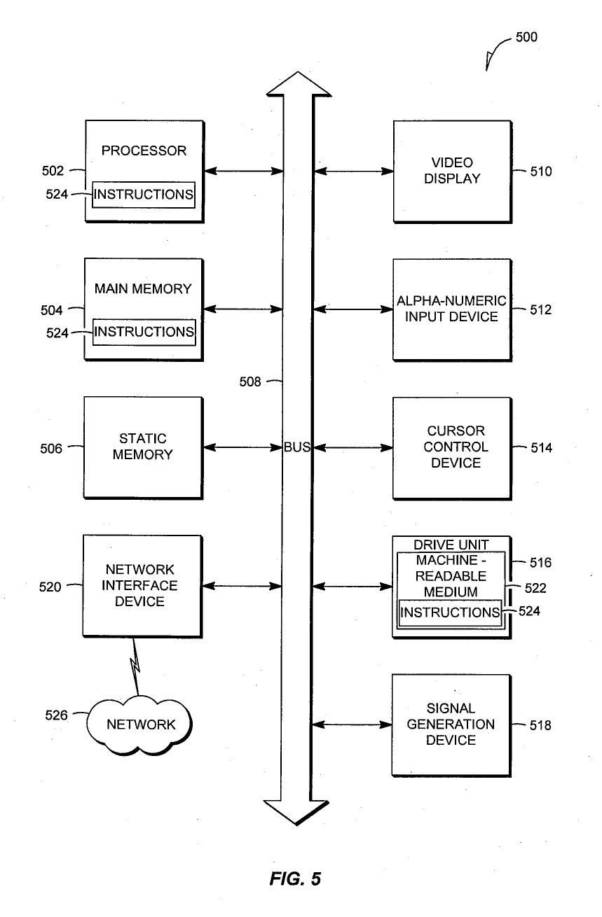

FIG. 5 shows a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 506. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter are referred to herein, individually or collectively, by the term “invention” merely for convenience and without intending to voluntarily limit the scope of this application to any single invention or inventive concept if more than one is, in fact, disclosed. In this description, for purposes of explanation, numerous specific details are set forth in order to provide a thorough understanding of an embodiment of the present invention. It will be evident, however, to one skilled in the art that the present invention may be practiced without these specific details. As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, any type of server environment, including various system architectures, may employ various embodiments of the application-centric resources system and method described herein and is considered as being within a scope of the present invention.

Thus, a method and system for generating document recommendations has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A computer-implemented method comprising:
detecting commencement of a subject task in an enterprise management system;
determining one or more further tasks in the enterprise management system that are same or similar to the subject task;
determining one or more documents from a document management system that were accessed while a task from the one or more further tasks is being executed;
selecting at least one recommendation document from the one or more determined documents; and
generating, using at least one processor, a recommendation comprising the at least one recommendation document.

2. The method of claim 1, comprising delivering the recommendation to a client computer system associated with a user performing the subject task.

3. The method of claim 2, wherein the delivering of the recommendation comprises delivering the recommendation to a desktop widget executing on the client computer system.

4. The method of claim 2, wherein the delivering of the recommendation comprises communicating the recommendation to a web browser executing on the client computer system.

5. The method of claim 2, wherein the delivering of the recommendation comprises pushing the recommendation to the client computer system in response to a triggering event.

6. The method of claim 1, wherein each document from the determined one or more documents comprise reading metadata, the reading metadata comprising information about access to a document by one or more users contemporaneously with executing any of the one or more further tasks.

7. The method of claim 6, wherein the selecting of the at least one recommendation document is based on the reading metadata.

8. The method of claim 7, wherein the reading metadata comprises reading duration information.

9. The method of claim 7, wherein the reading metadata comprises frequency of access information.

10. The method of claim 1, further comprising determining one or more documents from a document management system that were not accessed contemporaneously with executing any of the one or more further tasks.

11. A computer-implemented system comprising:
at least one processor;
a task commencement detector to detect commencement of a subject task in an enterprise management system;
a similar tasks detector to determine one or more further tasks in the enterprise management system that are same or similar to the subject task;
a document access information detector to determine one or more documents from a document management system that were accessed while a task from the one or more further tasks is being executed;
a document selector to select, using the at least one processor, at least one recommendation document from the one or more determined documents; and
recommendation generator to generate, using at least one processor, a recommendation comprising the at least one recommendation document.

12. The system of claim 11, comprising a recommendation delivery module to deliver the recommendation to a client computer system associated with a user performing the subject task.

13. The system of claim 12, wherein the recommendation delivery module is to communicate the recommendation to a desktop widget executing on the client computer system.

14. The system of claim 12, wherein the recommendation delivery module is to communicate the recommendation to a web browser executing on the client computer system.

15. The system of claim 12, wherein the recommendation delivery module is to push the recommendation to the client computer system in response to a triggering event.

16. The system of claim 11, wherein each document from the determined one or more documents comprise reading metadata, the reading metadata comprising information about access to a document by one or more users contemporaneously with executing any of the one or more further tasks.

17. The system of claim 16, wherein the document selector is to select the at least one recommendation document based the reading metadata.

18. The system of claim 17, wherein the reading metadata comprises one or more of reading duration information and frequency of access information.

19. The system of claim 11, wherein the document access information detector is to determine one or more documents from a document management system that were not accessed in association with the one or more further tasks.

20. A machine-readable non-transitory medium having instruction data to cause a machine to:
detect commencement of a subject task in an enterprise management system;
determine one or more further tasks in the enterprise management system that are same or similar to the subject task;
determine one or more documents from a document management system that were accessed while a task from the one or more further tasks is being executed;
select at least one recommendation document from the one or more determined documents; and
generate, using at least one processor, a recommendation comprising the at least one recommendation document.
